(19) United States
(12) Patent Application Publication
(10) Pub. No.: US 2014/0030689 A1
(43) Pub. Date: Jan. 30, 2014

(54) TESTING TIMER AND TESTING ANALYTICS

(71) Applicant: Sammy Schottenstein, Cincinnati, OH (US)

(72) Inventor: Sammy Schottenstein, Cincinnati, OH (US)

(21) Appl. No.: 13/951,601

(22) Filed: Jul. 26, 2013

Related U.S. Application Data
(60) Provisional application No. 61/676,141, filed on Jul. 26, 2012.

(51) Int. Cl. G09B 7/06

(52) U.S. Cl. CPC G09B 7/06
USPC 434/353

(57) ABSTRACT

Embodiments described herein disclose methods and systems to automatically present a checklist element to be completed by the medical practitioner. In embodiments, the medical practitioner may indicate that the presented checklist element is completed without using their hands. Therefore, the medical practitioner may maintain a sterile environment while completing checklist elements reducing the amount of time that the medical practitioner uses to complete a medical procedure.

### CROSS-REFERENCE TO RELATED APPLICATIONS

This application claims a benefit of priority under 35 U.S.C. §119 to Provisional Application No. 61/676,141, filed on Jul. 26, 2013, entitled “Software containing an algorithm for calculating performance based on time and accuracy,” which is fully incorporated herein by reference in its entirety.

### BACKGROUND INFORMATION

1. Field of the Disclosure

Examples of the present disclosure are related to techniques for determining a test taker's estimated score for a standardized test. Specifically, embodiments may determine test taker's estimated score for the standardized test based an amount of time the test taker took to answer a discrete set of questions from a section of the standardized test and the test taker's accuracy of the completed questions the discrete set of questions.

2. Background

Conventional standardized tests are administered and scored in a consistent manner. Standardized tests are designed in such a way that the questions, conditions for administering, scoring procedures, and interpretations of questions are consistent. Further, standardized tests are administered and scored in a predetermined, standard manner. Conventional standardized tests may be comprised of various subsections, where a test taker is given a predetermined amount of time to complete each individual subsection or a total amount of time to complete the entire test.

To study for a standardized test, the test taker may complete each section of the standardized test. Next, the test taker's scores for each of the subsections may be tabulated. Based on the tabulation of the test taker's scores for each of the subsections to test taker may be presented with the test taker's actual score of the standardized test.

In conventional systems, to determine the test takers performance on the standardized test while studying for the standardized test, it is required that the test taker complete each section of the standardized test before the test taker's performance on the standardized test. However, while practicing for the standardized test, requiring the test taker to complete each section of the standardized test to determine the test taker's score may be an inefficient or otherwise less than desirable solution to determine what sections the test taker is proficient in and what sections the test taker is not proficient in.

Accordingly, needs exist for more efficient and effective methods and systems to determine what sections of a standardized test a test taker is proficient in based on a time period and the test taker's accuracy of answering questions over a time period, wherein the time period may be any desired length of time.

### SUMMARY

Conventionally, preparatory materials and programs for standardized certificates, tests, admissions, assessments, evaluations, etc. (referred to hereinafter collectively and individually as “standardized tests”) do not provide feedback in the form of an estimated score based on the results of practicing a test.

Embodiments disclosed herein provide systems and methods to provide feedback associated with a test taker's performance on a standardized test based on time and accuracy. Embodiments are configured to incorporate data based on a test taker's accuracy of answers correctly answered for a section of the standardized test and time usage for answering questions to provide feedback.

The provided feedback may be in the form of an estimated score for the standardized test, whether the test taker is utilizing too much time or too little time to answer questions in a section of the standardized test, whether the test taker is proficiently answering questions in a section of the standardized test, determine the estimated score for the standardized test based on the user's performance of a subset of questions of a section of a standardized test, determine if the test taker should improve their proficiency in answering questions, and/or if the test taker should increase and/or decrease the amount of time the test taker utilizes per question in a section of a standardized test.

In embodiments, a test taker may select a standardized test that the test taker desires to practice from a group of standardized tests. For example, standardized test may include test associated with college admissions, professional school admissions, job certification, job certificates, etc.

In embodiments, responsive to selecting a standardized test, the test taker may select a section of the standardized test that they desire to assess their performance in. The sections of the standardized test may be different subjects, topics, themes, etc. that are within the standardized test. For example, sections may include reading comprehension, logic games, math, history, English, grammar, etc. In embodiments, the sections of the standardized test may also be a subsection of a subject. For example, if the standardized test is associated with the topic math, the subsections may be algebra, linear algebra, geometry, calculus, etc.

In embodiments, responsive to selecting a section of the standardized test the test taker may initiate a timer, and complete any desired amount of questions from the section. The amount of questions that the test taker completes may not be a predetermined amount, and the test taker may complete any number of questions for the sections that they desire or have time for in a study session.

In embodiments, responsive to the test taker completing a desired amount of questions for the section or spending a desired amount of time on the section, the test taker may stop the timer, determine how many questions they answered and determine how many questions they correctly answered.

In embodiments, a test equation may determine an estimated score for the test taker for the standardized test. The test equation may be based on the selected section of the standardized test, the amount of time between the timer being initialized and stopped, the amount of time allocated to the section of the standardized test, the number of questions of the section of the standardized test the user answered, and the number of questions of the section of the standardized test that the user correctly answered.

In embodiments, the estimated score for the test taker for the standardized test may represent an actual score for the test taker, if the test taker had completed the standardized test for all sections of the standardized test. The estimated score may be represented in a metric that corresponds to the standardized test. For example, a law school admissions test may be represented in a score from 120-180, whereas a college admissions test may be represented in a score from 0-2400.

In embodiments, the test equation may be based on data associated with previous tests for the standardized test or section of the standardized test. The test equation may determine a curve associated with the standardized test using relevant information for each standardized test or section of the standardized test. The test equation may be based on test data associated with the test taker's accuracy and time usage on a discrete set of questions for the section of the standardized test. The test equation may convert the test data based on the curve to a score on the curve for the standardized test.

In embodiments, responsive to the test taker's performance on the standardized test, the test taker may be presented with data indicating the test takers estimated score for the standardized test, how much time the test taker took per question in the section, the average amount of time desired per question in the section, an indicator indicating if the test taker's amount of time took per question is above or below the average amount of time desired per question.

These, and other, aspects of the embodiments will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of the embodiments, and the embodiments include all such substitutions, modifications, additions or rearrangements.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 depicts a topology for a testing system, according to one embodiment.

FIG. 2 depicts a block diagram of example components of a client computing device, according to one embodiment.

FIG. 3 depicts a block diagram of example components of testing server, according to one embodiment.

FIG. 4 illustrates a method for determining a test taker's average score for a standardized test, according to one embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present embodiments. It will be apparent, however, to one having ordinary skill in the art that the specific detail need not be employed to practice the present embodiments. In other instances, well-known materials or methods have not been described in detail in order to avoid obscuring the present embodiments.

Reference throughout this specification to “one embodiment”, “an embodiment”, “one example” or “an example” means that a particular feature, structure or characteristic described in connection with the embodiment or example is included in at least one embodiment of the present embodiments. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present embodiments may be implemented as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present embodiments may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present embodiments may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present embodiments. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

As used herein, the terms “comprises,” “comprising,” “includes,” “including,” “has,” “having,” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of any term or terms with which they are utilized. Instead, these examples or illustrations are to be regarded as being described with respect to one particular embodiment and as being illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” and “in one embodiment.”

Embodiments disclosed herein provide systems and methods to determine a test taker's performance on a standardized test based on time and accuracy, wherein to determine an estimated score for the standardized test it is only required that the test taker complete a discrete set of questions from one of the sections for the standardized test.

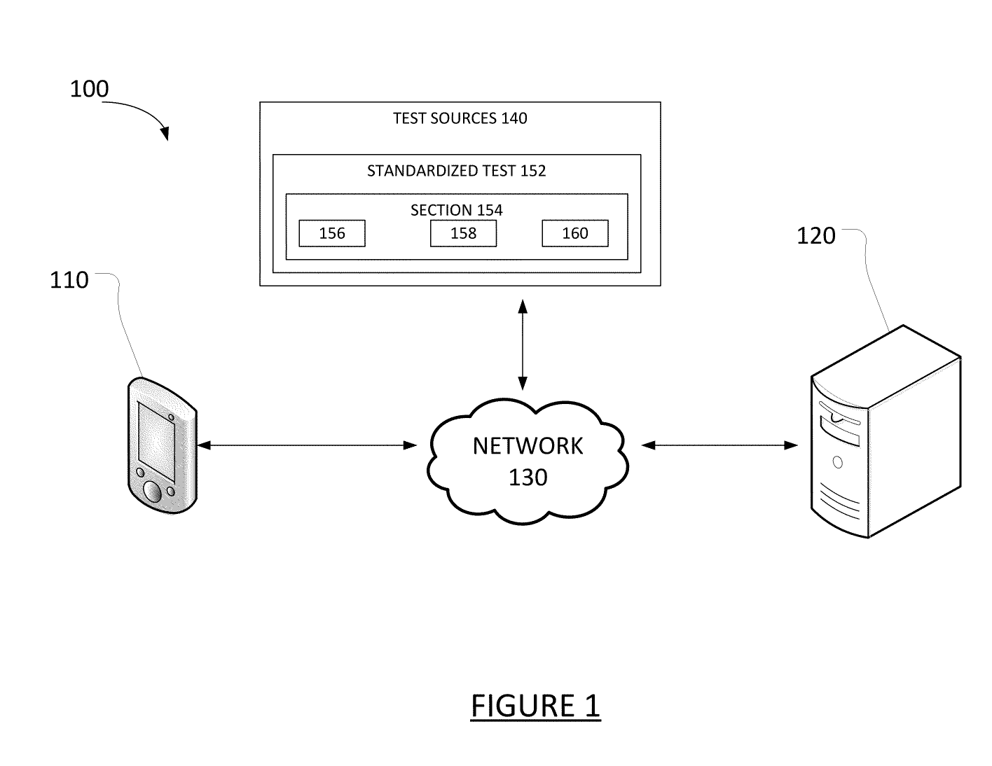

Turning now to FIG. 1, FIG. 1 depicts one topology 100 for determining a test taker's estimated standardized test score for a standardized test. Topology 100 includes one or more client computing devices 110 connected to test server 120 and test sources 140 over network 130.

Network 130 may be a wired or wireless network such as the Internet, an intranet, a LAN, a WAN, a cellular network or another type of network. It will be understood that network 130 may be a combination of multiple different kinds of wired or wireless networks.

Client computing device 110 may be a smart phone, tablet computer, laptop computer, personal data assistant, desktop computer or any other type of computing device with a hardware processor that is configured to process instructions and connect to one or more portions of network 130. Client computing device 110 may be configured to determine test information associated with a standardized test. In embodiments, client computing device 110 may be utilized to start a timer, end the timer, determine a time period between when the timer is started and ended, enter in a number of questions of the standardized test that the test taker answered over the time period, and/or enter a number of questions the test taker answered correctly over the timer period. In embodiments, client computing device 110 may be utilized to receive actions associated with a test taker selecting a standardized test, selecting a section of the standardized test, entering data associated with a discrete set of questions of the section of the standardized test, entering data associated with the amount of time the test taker used to answer the discrete set of questions, and/or entering time data representing a predetermining amount of time for the test taker to answer each question within the section of the standardized test.

Test server 120 may be a computing device such as a general hardware platform server that is configured to support mobile applications, software, computer code stored on a non-transitory computer readable medium, and the like executed on client computing device 110. Test server 120 may include physical computing devices residing at a particular location or may be deployed in a cloud computing network environment. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Test server 120 may include any combination of one or more computer-usable or computer-readable media. For example, test server 120 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Test server 120 may be configured to receive information associated with a standardized test and/or the test taker's performance of the discrete set of questions for section of the standardize test. Test server 120 may be configured to determine an estimated score for test taker, which represented in an actual score associated with the standardized test. Test server may determine the estimated score for the test taker based on the test taker completing a portion of a single section of the standardized test, the test taker's performance of the discrete set of questions for the single section of the standardized test, the amount of time the test taker took to complete the discrete set of questions, and a test equation associated with the standardized test. In embodiments, the estimated score may not be represented as a percentage of questions answered correctly and/or incorrectly.

Test server 120 may be configured to determine the estimated score for the standardized test based on historical data associated with the standardized score and/or the section of the standardized test, wherein the historical data may include average scores that achieved different results. The estimated score for the standardized test may be based on a curve, the amount of time to complete the sections of the standardized test, the test taker's performance of the standardized test, the standardized test selected, the section of the standardized test, the time required to answer the discrete set of questions, etc.

Test sources 140 may be sources of standardized tests 152. Test sources 140 may include hardware processing devices configured to transmit data associated with the standardized tests 152 to test server 120 over network 130. In embodiments, test sources 140 may be physically located and/or communicatively coupled to test server 120 over network 130. In other embodiments, test sources 140 may be books, magazines, flash cards, etc., or any other data source configured to present questions and answers to a test taker to simulate a standardized test 152.

In embodiments, a standardized test 152 may include different sections 154. The sections 154 may represent a sub-set of questions associated with a single topic, theme, subject, etc. for the standardized test. Each section 154 may include questions 156, answers 158, and a time 160 to complete section 154. Questions 156 may be questions that are realistic questions for standardized test 152, where questions 156 may actual questions for past standardized tests associated with section 154. Answers 158 may be the correct answers to corresponding questions 156. In embodiments, answers 158 may be the correct answer from a set of multiple choice answers presented to the test taker. Time 160 may be associated with a time to complete section 154. In embodiments, time 160 may be representative of an actual amount of time that the test taker would have to complete section 154 when taking an actual standardized test 152.

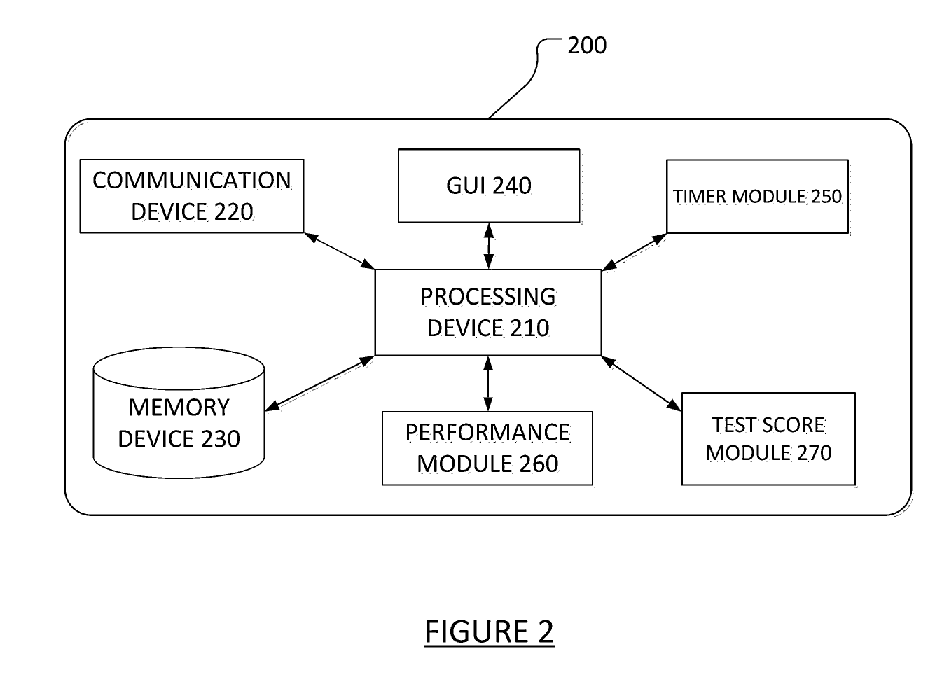

FIG. 2 depicts an embodiment of a block diagram illustrating example components of a client computing device 200, which may be a computing device that is, or is similar to client computing device 110, as depicting in FIG. 1. Consumer computing device 200 may include a processing device 210, a communication device 220, a memory device 230, a graphical user interface (GUI) 240, timer module 250, performance module 260, and test score module 270.

Processing device 210 can include memory, e.g., read only memory (ROM) and random access memory (RAM), storing processor-executable instructions and one or more processors that execute the processor-executable instructions. In embodiments where processing device 210 includes two or more processors, the processors may operate in a parallel or a distributed manner. Processing device 210 may execute an operating system of client computing device 200 or software associated with other elements of client computing device 200.

Communication device 220 may be a device that allows client computing device 200 to communicate with another device, e.g., test server or test sources over a network. Communication device 220 may include one or more wireless transceivers for performing wireless communication and/or one or more communication ports for performing wired communication.

Memory device 230 may be a device configured to store data generated or received by client computing device 200. Memory device 230 may include, but is not limited to a hard disc drive, an optical disc drive, and/or a flash memory drive. Memory device 230 may be configured to store data associated with a test taker's performance of standardized tests, standardized tests including corresponding answers and questions, and historical data associated with standardized tests utilized by test module 250.

GUI 240 may be a device that allows a test taker to interact with client computing device 200. While one GUI is shown, the term “user interface” may include, but is not limited to being, a touch screen, a physical keyboard, a mouse, a camera, a video camera, a microphone, and/or a speaker. GUI 240 may include inputs where the test taker may perform actions associated with a standardized test, such as selecting a standardized test, selecting a section of a standardized test, entering performance data associated with a standardized test, and/or initiating/stopping a timer associated with the section of the standardized test.

Timer module 250 may configured to determine an amount of time that has lapsed. In embodiments, timer module 250 may be a processing device that is configured to measure time intervals. Timer module 250 may count upwards from zero for measuring elapsed time. Timer module 250 may include a button or interface where the test taker may interact with the button or interface to initiate the timer. Responsive to the test taker performing first actions to interact with the button, the timer may initiate. In embodiments, responsive to the test taker performing second actions to interact timer module 250 may stop the timer. In embodiments, the test taker may perform the first actions to indicate that they are about to begin answering a discrete set of questions for a section of a standardized test, and the test taker may perform the second actions to indicate that they are stopping answering the discrete set of questions for the second of the standardized test. The amount of time between the first actions and the second actions may be a section time interval. In embodiments, the discrete set of questions and/or section time interval may be any desired amount, and may vary from testing session to testing session based on the amount of the test taker desires to spend on studying during different periods.

Performance module 260 may be configured to receive performance data associated with the test taker answering question associated with a standardize test. The performance data may including: determine how many questions the test taker answered during the time interval, wherein the number of questions represents the discrete set of questions, the number of questions the test taker correctly answered of the discrete set of questions, and the section time interval that the test taker took to answer the discrete set of questions, and an amount of time the test taker should spend to answer each question in the section of the standardized test. In embodiments, the test taker may perform actions on GUI 240 to enter the performance data. The performance data may be manually entered on GUI 240 by the test taker or the performance data may be automatically entered utilizing data stored at a test server. In embodiments, the performance data may be automatically transmitted to a test server responsive to the test taker using client computing device 200 to answer questions of a standardized test, and/or the user performing actions to initiate and stop the timer.

Test score module 270 may be configured to utilize the performance data to determine a scoring metric. In embodiments, the test scoring metric may represent an estimated actual score of the standardized test based on the test taker's performance data of the discrete set of questions for a section of the standardized test, the section time interval the test taker took to answer the discrete set of questions, and the amount of time the test taker should spend on the section of the standardized test. In embodiments, the estimated actual score of the standardized test may be presented to the test taker on GUI 240. Therefore, the test taker may efficiently and effectively determine what an estimate score that the test taker would receive for the standardize test without completing each section of the standardized test or even a single section of the standardized test. Thus, while preparing to study for a standardized test, the test taker may determine which sections the test taker is proficient in and what section the test taker is not proficient in without having to complete a single section of the standardized test, and only completing a discrete set of questions over any selected time period.

In embodiments, the test score metric may be based on a test equation, where the test equation for each standardized test may be different and/or each section within a standardized test may be different. The test equation for each standardized test and/or section of the standardized test may be based on empirical data associated with previous tests for the standardized test and/or sections of the standardized test. The test equation may determine a curve associated with the standardized test and/or section of the standardized test using relevant information for each standardized test. The test equation may be based on the performance data associated with the test taker's accuracy and time usage on a discrete set of questions for the section of the standardized test. The test equation may convert the performance data based on the curve to an estimated score on the curve for the test taker and the standardized test. In embodiments, responsive to the test taker's answering the discrete set of questions for the section of the standardized test over the section time interval, test module 270 may present data to the test taker on GUI 240 indicating the scoring metric for the standardized test, how much time the test taker took per question in discrete set of questions, the average amount of time desired per question in the section, an indicator indicating if the test taker's amount of time took per question is above or below the average amount of time desired per question.

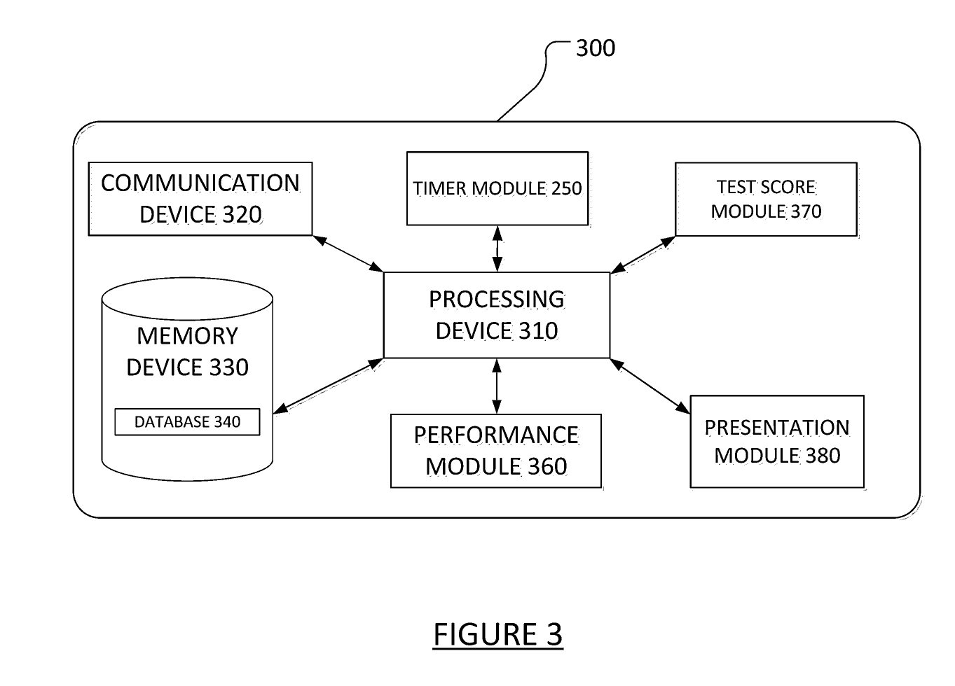

FIG. 3 depicts an embodiment of a block diagram depicting example components of a test server 300, which may be a computing device that is, or is similar to test server 120, as depicting in FIG. 1. Test server 300 may include a processing device 310, a communication device 320, a memory device 330 with a database 340, a timer module 350, a performance module 360, a test score module 370, and presentation module 380.

Processing device 310 may include memory, e.g., read only memory (ROM) and random access memory (RAM), storing processor-executable instructions and one or more processors that execute the processor-executable instructions. In embodiments where processing device 310 includes two or more processors, the processors may operate in a parallel or a distributed manner. Processing device 310 may execute an operating system of test server 300 or software associated with test server 300.

Communication device 320 may be a device that allows test server 300 to communicate with another device, e.g., test sources and/or client computing devices over a network. Communication device 320 may include one or more wireless transceivers for performing wireless communication and/or one or more communication ports for performing wired communication. In embodiments, communication device 320 may be configured to receive to be stored in database 340, and/or data to be utilized by modules 350, 360, 370, 380.

Memory device 330 may a device that stores data generated, transmitted, or received by test server 300. Memory device 330 may include, but is not limited to being a hard disc drive, an optical disc drive, and/or a flash memory drive. Memory device 330 may be accessible to processing device 310, communication device 320, and modules 350, 360, 370, 380.

In embodiments, memory device 330 may store a database 340 including a plurality of standardized tests for different types of tests. Database 340 may include entries of standardized tests that have sets of questions for different sections for a standardized test, where each standardized test and/or section of the standardized test may have their own globally unique identifier within database 340. In implementations, the entries for the sections of the standardized test may represent a sub-set of questions associated with a single topic, theme, subject, etc. for the standardized test. Each entry for a section of the standardized test may include questions, answers, a time to complete the section, and a test equation, wherein the test equation may be configured to determine a scoring metric for the standardized test based on the amount of time the test taker took to complete a discrete set of questions associated with the section, an amount of questions the test taker answered during the time period, and/or the amount of question the test taker correctly answered during the time period.

Timer module 350 may configured to receive data from a client computing device to determine an amount of time that a test taker has used to answer a discrete amount of questions for a standardized test. In embodiments, timer module 350 may be a processing device that is configured count upwards from zero to measure an elapsed time period. In implementations, responsive to timer module 350 receiving an indication from the client computing device indicating that the test taker has performed first actions to interact with a graphical user interface of the client computing device, timer module 350 may initiate the timer. In embodiments, responsive to timer module 350 receiving an indication from the client computing device indicating that the test taker has performed second actions to interact with the graphical user interface of the client computing device, timer module 350 may stop the timer. The amount of time between the first actions and the second actions may be a section time interval, wherein the section time interval may be any desired amount of time utilized by the test taker to complete the discrete set of questions. In embodiments, the discrete set of questions may be any desired amount, and may vary from testing session to testing session based on the amount of the test taker desires to spend on studying during different periods.

Performance module 360 may be configured to determine and/or receive performance data from the client computing device. The performance data may be associated with the test taker answering questions for a section of a standardized test over the section time period. In embodiments, the performance data may include: how many questions the test taker answered during the section time period, wherein the number of questions represents the discrete set of questions, the number of questions the test taker correctly answered of the discrete set of questions, and the section time interval that the test taker took to answer the discrete set of questions, and an amount of time the test taker should spend to answer each question in the section of the standardized test. In embodiments, the performance data may be received responsive to the test taker performing the second actions on the client computing device to stop the timer of timer module 350, or the test taker performing actions to manually enter the performance data on the client computing device.

Test score module 370 may be configured to utilize the performance data to calculate a scoring metric for the standardized test. In embodiments, the test scoring metric may represent an estimated actual score of the standardized test. The scoring metric may be based on the test taker's performance data of the discrete set of questions for the single section of the standardized test, the section time interval the test taker took to answer the discrete set of questions, the amount of time the test taker should spend on the section of the standardized test, and a test equation. In embodiments, the test equation may be associated with a single standardized test and/or section within a standardized test, where the test equation for each standardized test and/or section of the standardized test may be different. The test equation for each standardized test and/or section of the standardized test may be based on empirical data and/or historical data associated with previous tests for the standardized test. The test equation may determine a curve associated with the standardized test and/or section of the standardized test using relevant information for each standardized test. The test equation may convert the performance data based on the curve to an estimated score on the curve for the standardized test. In embodiments, the test equation may be based on a type of standardized test and the type of section of the standardized test, where test equations for different sections of the standardized test may be modified to represent an actual scoring range for the standardized test.

Presentation module 380 may be configured to transmit information to the client computing device. The transmitted information may be configured to be presented on a graphical display of the client computing device, wherein the transmitted data to be displayed on a display of the client computing may include the test taker's estimated score for the standardized test based on the number of questions the test taker answered, the number of questions the test taker correctly answered, the section time interval the test taker took to answer the questions, and an allotted time for the test taker to complete the section. In implementations, the transmitted data may also include the curve associated with the standardized test and the number of questions the test taker would have required to correctly answer to achieve different estimated scores for the standardized test.

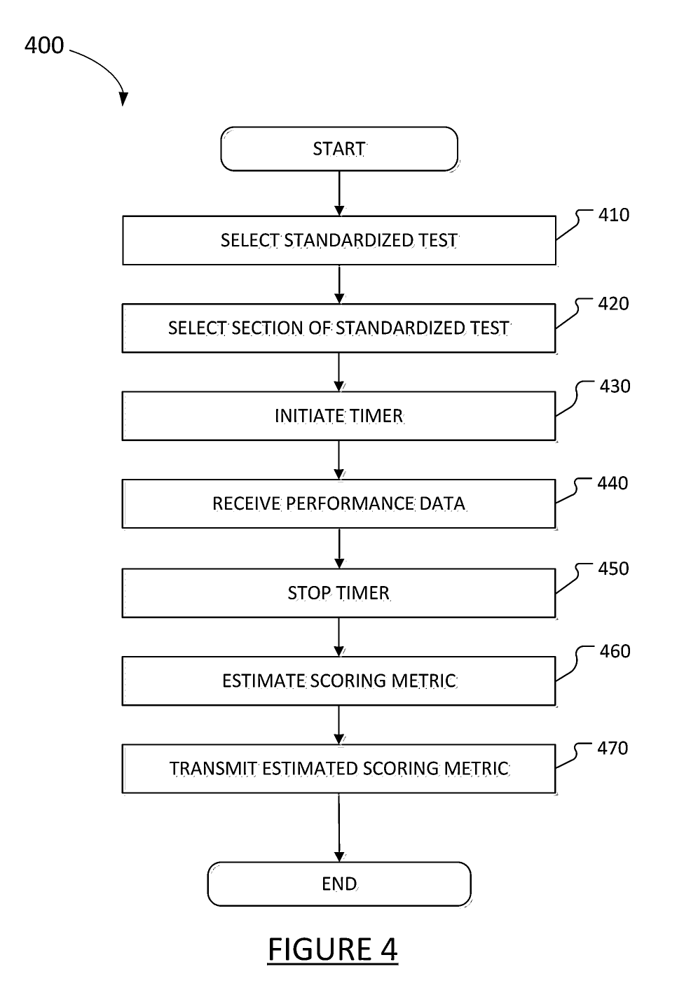

FIG. 4 illustrates a method 400 for transmitting estimating a test taker's score for a standardized test based on the test taker only answering a discrete set of questions from a section of the standardized test. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below are not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At operation 410, test selection data associated with a selection of a standardized test that a test taker desires to select may be received. The test selection data may be received responsive to the test taker performing actions on a graphical user interface to select a standardized test. Operation 410 may be performed by a communications device that is the same as or similar to communication device 320, in accordance with one or more implementations.

At operation 420, section data associated with a selection of a section of a standardized test that the test taker desired to select may be received. The section data may be received responsive to the test taker performing actions on the graphical user interface to select the section of the standardized test. Operation 420 may be performed by a communications device that is the same as or similar to communication device 320, in accordance with one or more implementations.

At operation 430, a timer may be initiated responsive to the test taker performing at least one action on the graphical user interface to initiate the timer. Operation 430 may be performed by a timer module that is the same as or similar to timer module 350, in accordance with one or more implementations.

At operation 440, performance data associated with the test taker answering questions may be received. The performance data may include the number of questions within the section of the standardized test that the test taker answered and the number of questions within the section of the standardized test that the test taker correctly answered. The performance data may be recorded automatically responsive to the test taker answering a question utilizing the graphical user interface, or the test taker may enter the performance data by performing actions on the graphical user interface to enter the performance data. Therefore, the performance data may be based on third party test sources with standardized tests such as books, as well as standardized test stored within a test server. Operation 440 may be performed by a performance module that is the same as or similar to performance module 350, in accordance with one or more implementations.

At operation 450, the timer may be stopped responsive to the test taker performing at least one action on the graphical user interface to stop the timer. The timer may be stopped at any desired time period when the test taker desires to no longer answer questions for the standardized test. Once the timer is stopped, the session time interval from the time period from when the timer is initiated to the timer is stopped may be determined. Operation 450 may be performed by a timer module that is the same as or similar to timer module 350, in accordance with one or more implementations.

At operation 460, an estimated scoring metric for the test taker for the standardized test may be determined based on section standardized test equation. In embodiments, the section standardized test equation may be a curve based on the number of questions the test taker took over the session time interval, the number of questions the test taker correctly answered over the session time interval, historical data associated with the section of the standardized test and/or the standardized test, and an allotted amount of time for the test taker to complete the section of the standardized test. Operation 460 may be performed by a test module that is the same as or similar to test module 370, in accordance with one or more implementations.

At operation 470, the estimated scoring metric for the standardized test may be transmitted to be presented on the graphical user interface of the client computing device. The estimated scoring metric may include the test taker's estimated score for the standardized test based on the number of questions the test taker answered, the number of questions the test taker correctly answered, and the time period the test taker took to answer the questions. In implementations, further data may be transmitted to be presented on the graphical user interface of the client computing device along with the estimated score. The further data may include the curve associated with the standardized test and the number of questions the test taker would have required to correctly answer to achieve different estimated scores for the standardized test. Operation 470 may be performed by a presentation module that is the same as or similar to presentation module 380, in accordance with one or more implementations.

Although the present technology is described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A method for determining an estimated standardized test score, the method comprising:
receiving, at a processor over a network, a selection of a section of a standardized test;
receiving performance data including a number of questions answered and a number of questions correctly answered;
receiving time data including an amount of time taken to answer the number of questions; and
determining the estimated standardized test score for a user based on a test equation, the test equation being based on the performance data, the time data, and an amount of time allocated to complete the section of the standardized test, wherein the test equation determined the estimated standardized test score based on historical data associated with the standardized test and the section of the standardized test.

2. The method of claim 1, wherein the test equation is different for a first section of the standardized test and a second section of the standardized test.

3. The method of claim 1, wherein the number of questions answered is a discrete set of questions within the section of the standardized test.

4. The method of claim 1, wherein the estimated standardized test score is represented in the same manner as actual results for the standardized test.

5. The method of claim 1, wherein the estimated standardized test score decreases as the number of questions correctly answered increases over the time period when the number of questions answered increases over the time period.

6. The method of claim 1, wherein the estimated standardized test score increases as the number of questions correctly answered decreases over the time period when the number of question answered decreases over the time period.

7. The method of claim 1, wherein the performance data is received by the user performing actions on a graphical user interface of a client computing device.

8. The method of claim 1, wherein the test equation converts the performance data based on the time period and a curve to determine the estimated standardized test score on the curve for the standardized test.

9. The method of claim 9, wherein the curve and the estimated standardized test score are configured to be presented to the user.

10. The method of claim 1, wherein the time period may be any desired period of time that is less than the amount of time allocated to complete the section of the standardized test.
